(19) United States
(12) Patent Application Publication
(10) Pub. No.: US 2026/0351839 A1
(43) Pub. Date: Nov. 5, 2026

(54) ELECTRONIC DEVICE AND ELECTRONIC TIMEPIECE

(71) Applicant: CASIO COMPUTER CO., LTD., Tokyo (JP)

(72) Inventors: Takeshi MATSUE, Tokyo (JP); Takashi SANO, Tokyo (JP); Tomoyasu KUROKAWA, Tokyo (JP); Takayuki SATOU, Tokyo (JP)

(21) Appl. No.: 19/112,195

(22) PCT Filed: Aug. 8, 2023
(86) PCT No.: PCT/JP2023/028952

§ 371 Date: Mar. 14, 2025

(30) Foreign Application Priority Data
Sep. 26, 2022 (JP) 2022-152059

(51) Int. Cl. H01Q 1/27; G04G 17/04

(52) U.S. Cl. CPC H01Q 1/273; G04G 17/04

(57) ABSTRACT

A timepiece, which is an electronic device, includes an antenna formed in an annular shape having at least an outer periphery and an inner periphery in a plan view from a first direction; and a circuit board on which a shield member serving as a protective member covering at least a portion of circuit elements is placed, the first direction is a direction orthogonal to a surface of the circuit board, and the antenna and the shield member are disposed at positions not overlapping each other in the plan view from the first direction.

### CROSS-REFERENCE TO RELATED APPLICATIONS

This application is a U.S. national phase application filed under 35 U.S.C. § 371 of International Application Number PCT/JP2023/028952 filed Aug. 8, 2023, designating the United States, which claims priority from Japanese Patent Application No. 2022-152059, filed Sep. 26, 2022, the entire disclosures of which are incorporated by reference herein.

### FIELD OF THE INVENTION

The present invention relates to an electronic device and an electronic timepiece.

### BACKGROUND OF THE INVENTION

In the related art, electronic devices such as electronic timepieces including antennae for global positioning system (GPS) reception have been known.

Members constituting the antenna (antenna element) are generally made of metal, and when the antenna is exposed to the outside air, there is a concern that it may oxidize or corrode.

Therefore, it is preferable that the antenna is accommodated in the electronic device as much as possible, and for example, Patent Literature 1 describes a configuration in which an antenna is accommodated in a case of a timepiece (electronic timepiece).

### CITATION LIST

### Patent Literature

Patent Literature 1: JP2015-175673A

### SUMMARY OF INVENTION

However, since electronic devices such as electronic timepieces are expected to be worn on a wrist and the like when used, there is a general trend toward reduction in size in order to improve usability, and the like.

Therefore, a distance between an antenna (antenna element) and a portion (for example, a case) that is capacitively coupled to the antenna and a portion (for example, a circuit board) that functions as a ground (hereinafter, abbreviated as GND) tends to be close.

However, the closer the distance between the antenna (antenna element) and the like and the GND (circuit board and the like), the more likely antenna efficiency will be reduced regardless of a frequency.

In particular, when a shield case is disposed on the circuit board, the shield case becomes a GND potential, but the shield case is located closer to the antenna (antenna element) than the circuit board is, and the distance between the antenna (antenna element) and the GND is further reduced.

Therefore, there has been a problem that electrical coupling (capacitive coupling) such as a parallel plate capacitor is likely to occur between the antenna (antenna element) and the GND (the shield case and the like), and the antenna efficiency tends to reduced.

The present invention has been made to solve the above problems, and an object thereof is to provide an electronic device and an electronic timepiece capable of suppressing a reduction in antenna efficiency.

In order to solve the above problems, an electronic device according to the present invention includes:
an antenna; and
a circuit board on which a protective member that covers at least a portion of circuit elements is placed,
in which the antenna and the protective member are disposed at positions not overlapping each other in a plan view from a first direction orthogonal to a surface of the circuit board.

According to the present invention, the reduction in the antenna efficiency can be suppressed.

### BRIEF DESCRIPTION OF DRAWINGS

FIG. 1 is a main portion exploded perspective view of a timepiece in an embodiment.

FIG. 2 is a front view of the timepiece in the embodiment.

FIG. 3 is a cross-sectional view taken along a line III-III of the timepiece in the embodiment shown in FIG. 2.

FIG. 4 is a main portion enlarged cross-sectional view of a portion IV in FIG. 3.

FIG. 5 is a cross-sectional view taken along a line V-V of the timepiece in the embodiment shown in FIG. 2.

FIG. 6 is a main portion enlarged cross-sectional view of a portion VI in FIG. 5.

FIG. 7A is a main portion enlarged perspective view of a portion VII in FIG. 2.

FIG. 7B is a schematic cross-sectional view taken along a line VIIB-VIIB in FIG. 7A.

FIG. 8 is a main portion cross-sectional view showing a state in which a bezel is removed from the timepiece in the embodiment.

FIG. 9 is a plan view of a solar panel in the present embodiment.

FIG. 10 is a main portion side view showing a configuration of connection portions between a solar panel and a circuit board in the present embodiment.

FIG. 11A is a plan view of an antenna in the present embodiment.

FIG. 11B is a perspective view of the antenna shown in FIG. 11A.

FIG. 11C is a side view of the antenna shown in FIG. 11A.

FIG. 12A is a main portion plan view showing a fixing structure of the antenna inside the timepiece in the embodiment.

FIG. 12B is an enlarged view of an XIIB portion in FIG. 12A.

FIG. 12C is an enlarged view of an XIIC portion in FIG. 12A.

FIG. 13 is an illustrative diagram illustrating wavelength shortening of the antenna.

FIG. 14 is a view showing a configuration of a connection portion between the antenna and the circuit board in the present embodiment, and is a main portion side view in which a portion is shown in cross section.

FIG. 15A is a perspective view of the antenna in the present embodiment.

FIG. 15B is a perspective view of an antenna of Comparative Example 1.

FIG. 15C is a perspective view of an antenna of Comparative Example 2.

FIG. 16 is a main portion plan view showing an internal configuration of the timepiece in the embodiment.

### DETAILED DESCRIPTION

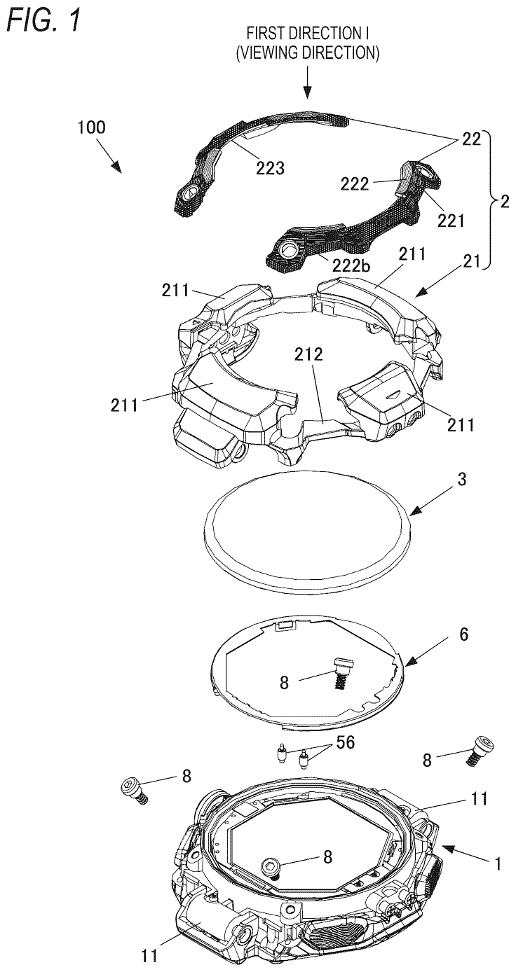

An electronic device (and an electronic timepiece) according to an embodiment of the present invention will be described with reference to FIGS. 1 to 16. In the present embodiment, a case where the electronic device is the electronic timepiece including an antenna will be described as an example.

It should be noted that although the embodiments described below are provided with various limitations that are technical preferable for carrying out the present invention, the scope of the present invention is not limited to the following embodiments and illustrated examples.

### [Configuration]

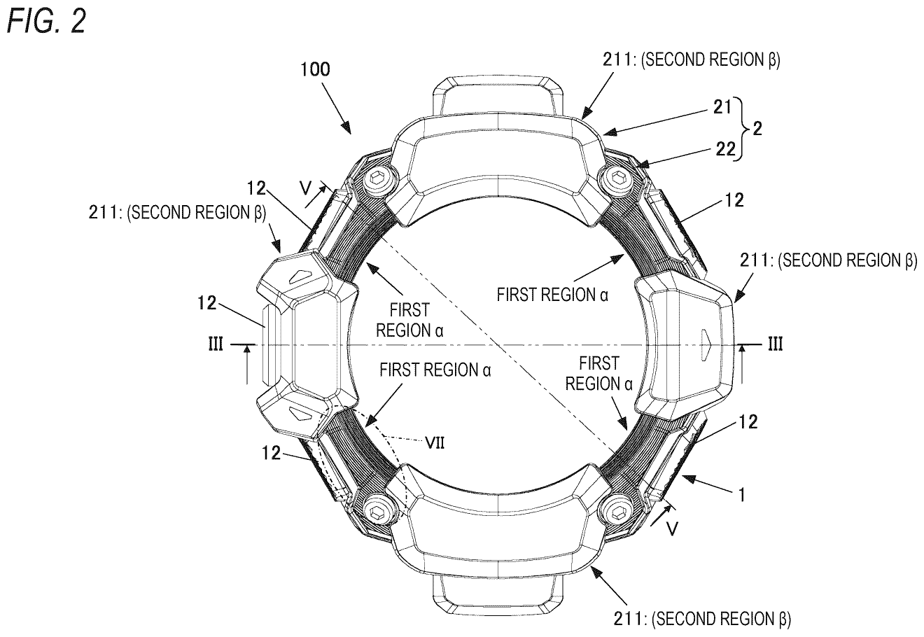

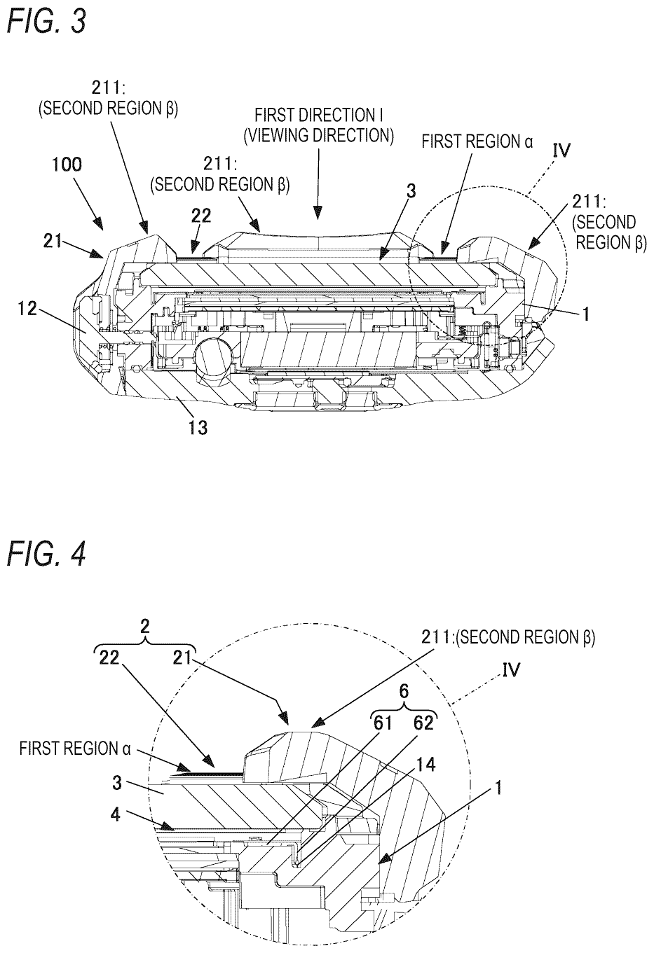

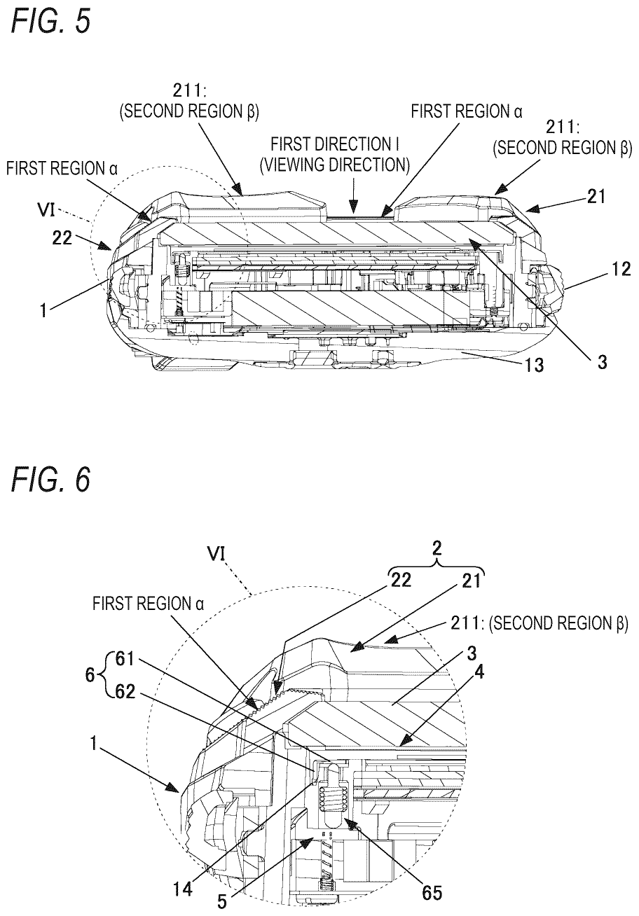

FIG. 1 is a main portion exploded perspective view of the electronic timepiece (hereinafter, simply referred to as a “timepiece”) serving as the electronic device in the present embodiment, and FIG. 2 is a front view of the timepiece shown in FIG. 1. FIG. 3 is a schematic main portion cross-sectional view taken along a line III-III in FIG. 2, and FIG. 4 is an enlarged view of a portion IV surrounded by a broken line in FIG. 3. Further, FIG. 5 is a main portion cross-sectional view taken along a line V-V in FIG. 2, and FIG. 6 is an enlarged view of a portion VI surrounded by a broken line in FIG. 5.

As shown in FIGS. 1 to 6, a timepiece 100 according to the present embodiment includes a device case 1.

The device case 1 of the present embodiment is formed in a hollow short cylindrical shape that is open at the top and bottom, and the internal hollow portion forms a storage space for storing various components.

The device case 1 is formed of, for example, a comparative hard synthetic resin such as biomass plastic, engineering plastic, or super engineering plastic. The material for forming the device case 1 is not limited to those illustrated, and various resin materials having a high relative dielectric constant as described later are more preferable.

A pair of band attachment portions 11 (see FIG. 1) to which a band (not shown) is attached are provided at upper and lower positions (a 12 o'clock position and a 6 o'clock position in an analog timepiece) of an outer side surface of the device case 1 in FIG. 2.

On left and right side portions and the like in FIG. 2 of the device case 1, various operation buttons 12 (push buttons, crowns and the like) for a user to perform various input operations are provided.

As shown in FIGS. 3 and 5, an opening portion on a back surface side of the device case 1 (a non-viewing side in the timepiece) is closed by a back cover member 13. The back cover member 13 may be formed integrally with the device case 1.

A bezel 2 serving as an exterior member is provided on a front surface side (a viewing side in the timepiece) of the device case 1 so as to surround the opening portion. The bezel 2 is fixed to the device case 1 by, for example, screws 8.

The bezel 2 is a member formed in a substantially annular shape when the timepiece 100 is viewed from the viewing side (hereinafter, referred to as a “first direction I”). The bezel 2 has first regions a each having at least a surface on which a metal is discontinuously vapor-deposited on a base material containing the resin material, and second regions β formed with the resin material (where the metal is not discontinuously vapor-deposited).

In the present embodiment, the bezel 2 includes a first bezel 21 formed of the resin material such as urethane, and a second bezel 22 having at least a surface on which a metal is discontinuously vapor-deposited on the base material containing the resin material such as urethane. A portion where the second bezel 22 is exposed on the surface (surface on the viewing side) is the first region a, and a portion where the second bezel 22 is covered with the first bezel 21 and does not appear on the surface (surface on the viewing side) is the second region B.

Specifically, as shown in FIG. 1 and the like, the first bezel 21 has, along a circumferential direction of the bezel 2, protrusion forming portions 211 protruding from the other portion (a main body portion 212 of the first bezel 21) at a 3 o'clock position, the 6 o'clock position, a 9 o'clock position, and the 12 o'clock position in the analog timepiece. The protrusion forming portion 211 protrudes from the main body portion 212 toward at least a thickness direction (an upper direction in FIG. 3 and the like) of the timepiece 100 and a radially outer side of the bezel 2.

All or a portion of the protrusion forming portions 211 is attachable to and detachable from the main body portion 212 of the first bezel 21.

In the present embodiment, for example, the second bezel 22 is disposed on the main body portion 212 in a state in which all or the portion of the protrusion forming portions 211 is removed from the main body portion 212. Then, by attaching the removed protrusion forming portion 211 to the main body portion 212, the second bezel 22 is sandwiched between the main body portion 212 and the protrusion forming portion 211 of the first bezel 21 to form the integrated bezel 2.

By forming the bezel 2 with the resin material such as urethane, the weight of the bezel 2 can be reduced, and the degree of freedom in the shape is improved compared to when the bezel 2 is formed by metalworking. Further, by providing the bezel 2 formed of the resin material as the exterior member of the timepiece 100, the impact resistance of the timepiece 100 is also improved compared to when the bezel 2 is formed of the metal material.

For example, a metal such as indium (In) is discontinuously vapor-deposited on the surface of the second bezel 22. By discontinuously vapor-depositing (thin-film vapor-Clean depositing) indium and the like, a metallic appearance is realized, and a space is generated between metal particles, for example, even when the bezel 2 including the second bezel 22 is disposed on an antenna 6 (see FIG. 1 and the like) and the like, it is possible to prevent radio waves from being shielded. A transparent film made of a resin and the like may be further formed on the discontinuously vapor-deposited metal layer, and in this case it is possible to obtain a glossy appearance and realize resistance to scratches. Further, an indium (In) alloy may peel off when it hits or rubs against an object. In this regard, if a transparent film made of the resin and the like is formed on the surface, peeling of the discontinuously vapor-deposited metal layer such as the indium (In) alloy can be prevented even if the second bezel 22 hits surrounding objects during use. Accordingly, a beautiful metallic appearance is maintained for a long time.

The discontinuously vapor-deposited metal is not limited to indium (In), and various alloys such as tin (Sn) can be applied.

The discontinuously vapor-deposited metal layer may be formed on the entire surface of the second bezel 22, or only on a portion that may be exposed to the outside.

The portion that may be exposed to the outside is an upper surface 221 or a side surface 222 of the second bezel 22. However, the discontinuous vapor-deposition of the metal may be performed on the entire upper surface 221 or the entire side surface 222, but even on the upper surface 221 or the side surface 222 of the second bezel 22, the portions sandwiched between the main body portion 212 and the protrusion forming portions 211 of the first bezel 21 are not exposed to the outside in an assembled state. Therefore, these positions may not be subjected to the discontinuous vapor-deposition of the metal.

For example, a cross-sectional portion taken along the line III-III in FIG. 2 shown in FIG. 3 is a portion where the protrusion forming portions 211 of the first bezel 21 cover the second bezel 22 to form the second regions B. As shown in FIGS. 3 and 4, in the second region β, the protrusion forming portion 211 of the first bezel 21 is disposed on an outer side, and as described above, the second bezel 22 is sandwiched between the main body portion 212 and the protrusion forming portion 211 of the first bezel 21 and is not exposed to the outside. Therefore, in this portion, not only a back surface 223 of the second bezel 22 but also the upper surface 221 (surface) and the side surface 222 may not be subjected to the discontinuous vapor-deposition of the metal.

In this way, by not performing discontinuous vapor-deposition on non-viewing portions, the amount of metal material to be vapor-deposited can be saved. Further, when the discontinuous vapor-deposition is not performed on the portion (the back surface 223 and the like) that is not visible, a vapor-deposition operation can be performed in a state in which the second bezel 22 is disposed on a table with the back surface 223 and the like facing down, and a work process is simplified.

On the other hand, a cross-sectional portion taken along the line V-V in FIG. 2 shown in FIG. 5 is a portion where the upper surface 221 (surface) and the side surface 222 of the second bezel 22 form the first region a exposed to the viewing side. The first region a and the second region β are alternately arranged along the circumferential direction of the bezel 2.

Specifically, as shown in FIG. 2, in the present embodiment, the protrusion forming portions 211 constituting the second region β are arranged at substantially equal intervals along the circumferential direction of the bezel 2, and the first region a is disposed between the protrusion forming portions 211 constituting the second regions β. The protrusion forming portion 211 constituting the second region β is formed such that at least a height of an upper surface thereof is higher than a height of an upper surface of the portion where the second bezel 22 is exposed, which is the first region a. Therefore, it is possible to protect the exposed second bezel 22 from an external impact and the like, and it is possible to prevent the portion having the metallic appearance from being damaged.

Further, in the present embodiment, the upper surface 221 and the side surface 222 that are likely to be exposed to the outside in the second bezel 22 are subjected to, for example, V-groove processing (drawing processing (record drawing), hairline processing, and the like), and a groove portion 22a is concentrically formed. Accordingly, when the metal is discontinuously vapor-deposited, a more metallic texture can be produced.

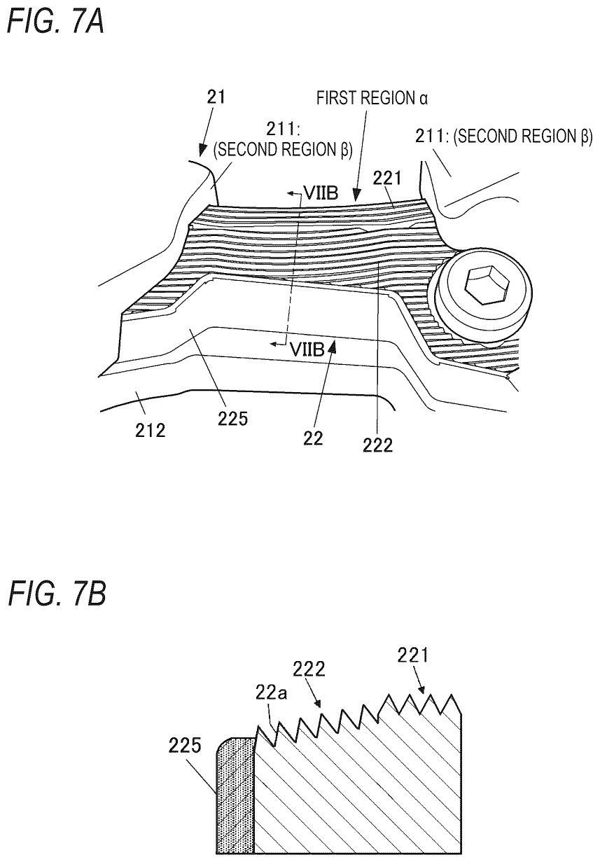

FIG. 7A is an enlarged view of a portion VII surrounded by a one-dot chain line in FIG. 2, and FIG. 7B is a cross-sectional view taken along a line VIIB-VIIB in FIG. 7A. FIG. 7B is a schematic view schematically illustrating a cross-sectional state taken along the line VIIB-VIIB, and does not accurately represent the shape of the groove portion 22a, the number and a depth of grooves, and the like.

When the V-groove processing is performed on the bezel 2 (the second bezel 22), the cross section of the bezel 2 in the radial direction becomes uneven, which deteriorates an appearance and a touch feeling. Here, in the present embodiment, as shown in FIGS. 7A and 7B, an edge portion 225 is provided to build up a periphery of the cross section of the portion subjected to the V-groove processing (the side surface 222 in which the groove portion 22a is formed, and the like) so that the cross section is not exposed to the outside, thereby preventing unevenness from appearing on the cross section. The V-groove processing of forming the groove portion 22a and a method of forming the edge portion 225 is not particularly limited, for example, it is conceivable to adopt a metal mold having a shape corresponding to the groove portion 22a and the edge portion 225 and perform molding.

Although FIG. 7B illustrates a case where the edge portion 225 that builds up the periphery of the cross section to a height at which about half of the V-groove of the groove portion 22a is hidden is provided, the height of the edge portion 225 is not limited thereto. For example, an edge portion that builds up the periphery of the cross section to a height at which the cross section of the entire V-groove is hidden may be provided.

In the present embodiment, as shown in FIG. 1, the second bezel 22 is divided into two members, but the second bezel 22 may be an integrated member having a substantially annular shape, a C shape, a U shape, and the like when viewed from the first direction I (see FIGS. 1 and 3, and the like) as long as the second bezel 22 can be sandwiched between the main body portion 212 and the protrusion forming portion 211 of the first bezel 21. The second bezel 22 may be divided into even smaller parts, such as four parts.

Further, the positions where the protrusion forming portions 211 are provided are not limited to those illustrated, but the protrusion forming portions 211 are preferably disposed at substantially equal intervals along the circumferential direction so as to be able to reliably protect the portions (the first regions a) where the second bezel 22 having the metallic appearance is exposed. The protrusion forming portions 211 only need to be distributed at a plurality of positions along the circumferential direction of the bezel 2, for example, at three positions. Further, it is not essential that the protrusion forming portion 211 is attachable to and detachable from the main body portion 212. Further, the protrusion forming portions 211 may not be individually attached to and detached from the main body portion 212, and may be integrally attached to and detached from the main body portion 212.

In the present embodiment, the bezel 2 includes the first bezel 21 on which a metal is not discontinuously vapor-deposited in addition to the second bezel 22 having the metallic appearance, and the portion (the first region a) where the portion having the metallic appearance is exposed is protected by the first bezel 21, but the bezel 2 may not include the first bezel 21 as long as the adhesion of the metal layer such as the indium (In) alloy discontinuously vapor-deposited can be improved and a configuration in which peeling and the like hardly occurs can be obtained.

In the present embodiment, since the bezel 2 provided to surround the opening portion on the front surface side of the device case 1 is formed of the resin material 2 such as urethane, even when an impact is received from the outside, the bezel 2 absorbs the impact, and it is possible to effectively prevent breakage of the device case 1, a timepiece movement (for example, a circuit board 5 to be described later, a liquid crystal panel unit 7, various motors (not shown)) accommodated in the device case 1, and the like.

In the present embodiment, the case where the member constituting the second regions β (the first bezel 21 having the protrusion forming portions 211) and the member constituting the first regions a (the second bezel 22 obtained by performing the metallic processing on at least the exposed portion) are separate members has been illustrated, but a bezel having the second regions β and the first regions a may be integrally formed, and a metallic portion and the like may be partially processed.

The opening portion on the front surface side (the viewing side in the timepiece) of the device case 1 is closed by a windshield member 3. The windshield member 3 is a transparent member formed of, for example, a glass material or a transparent resin material. The windshield member 3 is preferably attached to the device case 1 via a resin waterproof ring and the like. Accordingly, waterproofness (airtightness) in the device case 1 can be ensured.

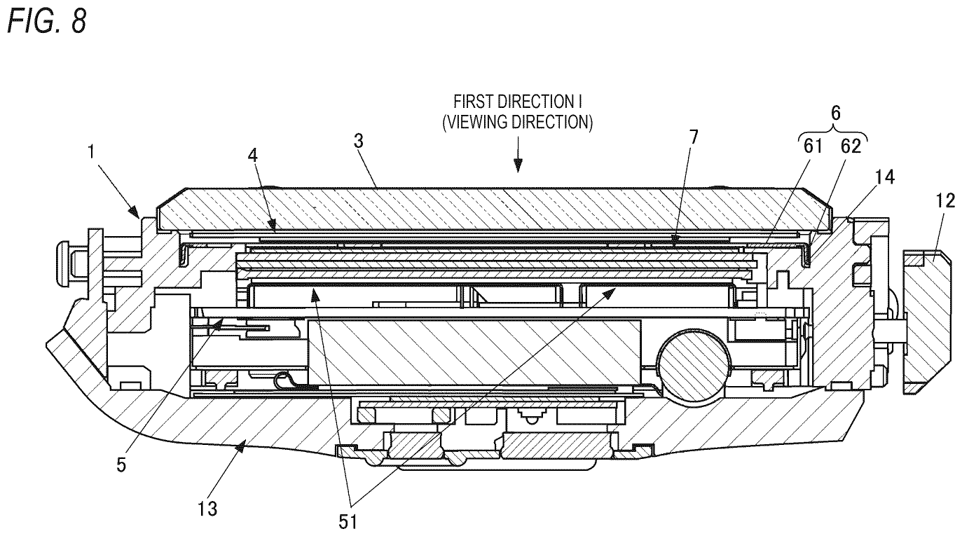

FIG. 8 is a cross-sectional view of the timepiece with the bezel 2 removed.

In the present embodiment, as shown in FIG. 8, a solar panel 4 is attached to a back surface side of the windshield member 3 (that is, a side disposed inside the device case 1).

The solar panel 4 is a solar cell that generates power by receiving light, and the generated power obtained by photovoltaic power generation by the solar panel 4 is stored in a secondary battery accommodated in the device case 1 and serves as a power source of each unit of the timepiece 100.

In the present embodiment, the solar panel 4, the antenna 6 to be described later, and the circuit board 5 are arranged in this order in the thickness direction (the first direction I) of the timepiece 100 along the first direction I (the direction substantially orthogonal to a surface of the circuit board 5), and the solar panel 4 is positioned so as to at least partially overlap the antenna 6 in a plan view from the first direction I.

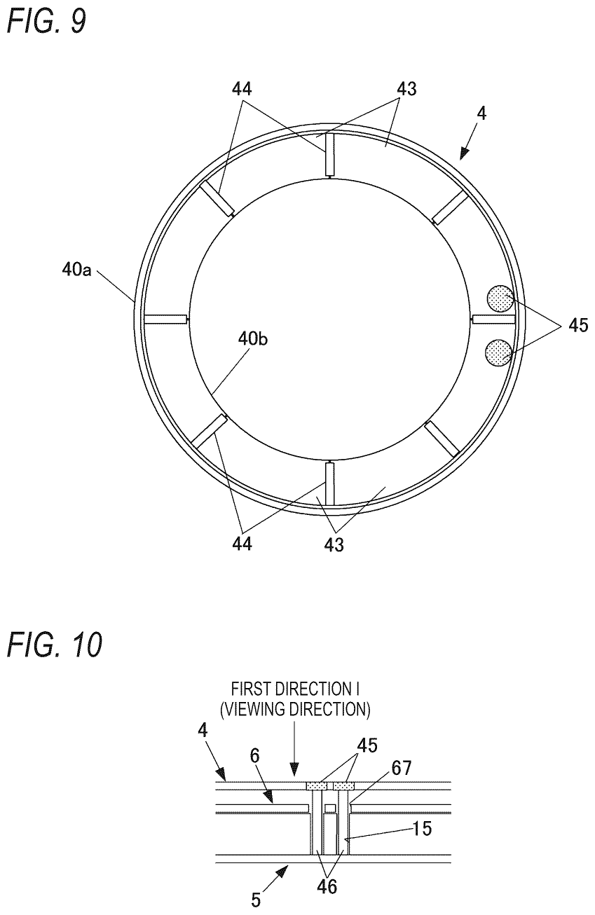

FIG. 9 is a plan view of a solar panel according to the present embodiment.

As shown in FIG. 9, the solar panel 4 of the present embodiment is a panel formed in a hollow ring shape (annular shape) having at least an outer periphery 40a and an inner periphery 40b in the plan view from the first direction I.

In the present embodiment, dividing lines 44 are arranged at substantially equal intervals along a radial direction of the ring-shaped solar panel 4, and the solar panel 4 is divided into a plurality of substantially fan-shaped cells 43 by the dividing lines 44. In the illustrated example, the solar panel 4 is divided into eight cells 43, but the number of cells 43 into which the solar panel 4 is divided is not particularly limited. The plurality of cells 43 constituting the solar panel 4 are connected in series, and are connected to the circuit board 5 (see FIGS. 8 and 10) in a contact portion 45 as described later.

FIG. 10 is an illustrative diagram schematically showing a connection portion between the solar panel and the circuit board. As shown in FIG. 10, the solar panel 4 is connected to the circuit board 5 by providing at least one board-panel contact member 46 (panel contact member) between the contact portion 45 of the solar panel 4 and a solar panel connection terminal (pad) (not shown) of the circuit board 5. In the present embodiment, as shown in this figure, two board-panel contact members 46 are provided.

The board-panel contact member 46 is, for example, a coil spring, and both end portions thereof are electrically coupled to the solar panel 4 and the circuit board 5, respectively.

As shown in FIG. 8 and other figures, the antenna 6 is disposed between the solar panel 4 and circuit board 5 of the present embodiment, and the board-panel contact members 46 are disposed to overlap the solar panel 4, the antenna 6, and the circuit board 5 in the plan view from the first direction I.

Specifically, as schematically shown in FIG. 10, hole portions 15 vertically penetrating the device case 1 are formed corresponding to positions where the board-panel contact members 46 are disposed. The board-panel contact member 46 is positioned by being inserted into the hole portion 15, and a posture thereof is also held in a way that the end portions are in contact with the solar panel 4 and the circuit board 5, respectively. As described later, cutout portions 67 are formed in the antenna 6 to avoid positions where the board-panel contact members 46 are disposed.

The antenna 6 according to the present embodiment is, for example, a GPS antenna capable of receiving global navigation satellite system (GNSS) signals (GPS/GLONASS/QZSS/SBAS and the like, hereinafter, simply referred to as “GNSS (GPS) signals”) transmitted from a GPS satellite and the like (including GLONASS and the like other than the GPS, but also simply referred to as “GPS” in the following description). The GPS satellite is equipped with an atomic timepiece and transmits data including time information according to the atomic timepiece. When the GNSS (GPS) signal transmitted from the GPS satellite is received by the antenna 6, time information with extremely high accuracy can be obtained at any reception point on the ground.

The antenna 6, which is the GPS antenna that receives the GNSS (GPS) signal, needs to be compatible with a clockwise polarized wave among circularly polarized waves.

Further, the GPS satellite transmits a GNSS (GPS) signal at a frequency such as an L1 band (around 1.6 GHZ) and an L5 band (around 1.2 GHZ). Therefore, desired frequency bands for the GPS antenna that receives the GNSS (GPS) signal are the L1 band, the L5 band, and the like, and it is desirable that the antenna 6 has high antenna performance (particularly, an antenna gain corresponding to the clockwise polarized wave) in these frequency bands.

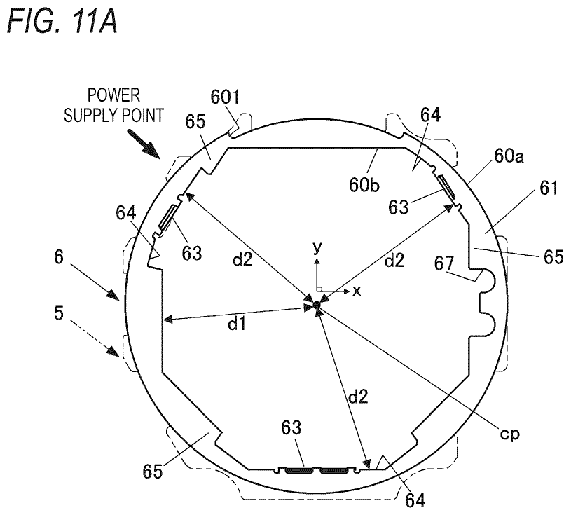

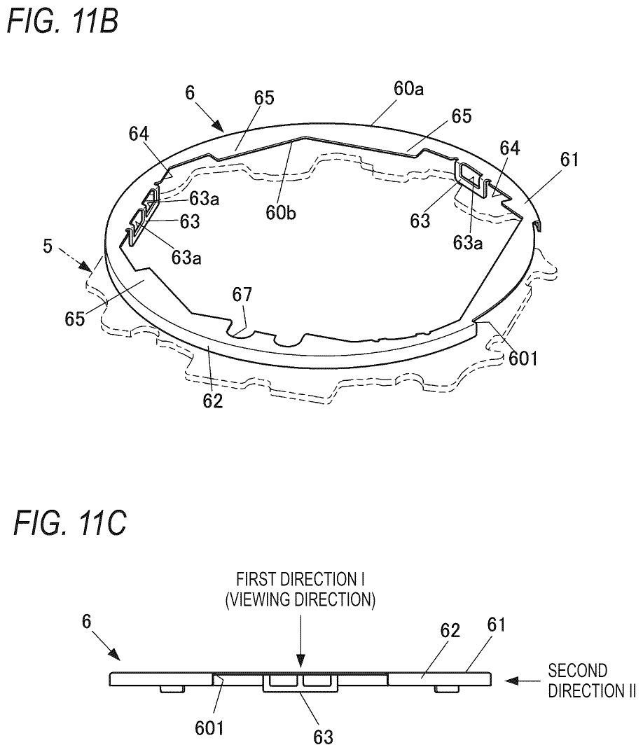

FIG. 11A is a plan view of the antenna of the present embodiment as viewed from the first direction, FIG. 11B is a perspective view of the antenna, and FIG. 11C is a side view of the antenna when the antenna is viewed from a second direction different from the first direction.

As shown in FIG. 11A and the like, the antenna 6 (an antenna element portion of the antenna 6) is formed in an annular shape having at least an outer periphery 60a and an inner periphery 60b in a plan view from the first direction I. The material of the antenna 6 is not particularly limited, but as a metal material for forming a high-frequency antenna element, the lower an electrical volume resistivity, the more preferable the material is. It is also conceivable that electronic devices such as the timepiece 100 (the electronic timepiece and the like) may be equipped with a geomagnetic sensor, and a non-magnetic material is more preferable in consideration of an effect on geomagnetic measurement. From this point of view, for example, phosphor bronze is preferably used as the material of the antenna 6 (the antenna element portion of the antenna 6). An antenna function is realized by a high-frequency current flowing through the annular antenna 6 (the antenna element portion of the antenna 6) and the circuit board 5 (GND plate).

As shown in FIGS. 11A to 11C, the antenna 6 (the antenna element portion of the antenna 6) of the present embodiment has a top surface portion 61 whose main surface is visible in a plan view from the first direction I, and a side surface portion 62 connected to at least a portion of the top surface portion 61 and extending along the first direction I. At least a portion of the side surface portion 62 extends substantially in the first direction I from the outer peripheral edge of the top surface portion 61, and a main surface is visible from a second direction II different from the first direction I (in the present embodiment, the second direction II is a direction from a side portion of the timepiece 100 substantially orthogonal to the first direction I). Specifically, the antenna 6 includes the annular top surface portion 61, and the side surface portion 62 that is vertically provided from an outer peripheral edge of the top surface portion 61 and is viewed from the second direction II different from the first direction I (in the present embodiment, the second direction II is a direction from the side portion of the timepiece 100 substantially orthogonal to the first direction I).

The larger a surface area of the antenna 6 (the surface area of the antenna element of the antenna 6), the more advantageous it is in terms of radio wave radiation.

In this regard, since the antenna 6 includes the top surface portion 61 and the side surface portion 62 as in the present embodiment, it is possible to secure the surface area without increasing the diameter of the entire antenna 6 as compared with the case where only a flat portion of a top surface (the top surface portion 61) or only a ring (only the side surface portion 62) is provided, which is preferable from the viewpoint of the radio wave radiation.

As described later, the circuit board 5 is disposed below the antenna 6, and when the antenna 6 (the antenna element portion of the antenna 6) is disposed parallel to the circuit board 5, capacitive coupling is likely to occur, which adversely affects the radio wave radiation. Since the side surface portion 62 is disposed substantially orthogonal to the circuit board 5, the capacitive coupling is unlikely to occur. Therefore, the surface area of the antenna 6 (the antenna element portion of the antenna 6) can be increased while avoiding the occurrence of the capacitive coupling as much as possible.

On the other hand, the length (the length of one circumference) of an inner diameter side of the antenna 6 (the antenna element of the antenna 6) is shorter (that is, the inner diameter is narrower) in the case where the top surface portion 61 is provided than in the case where only the side surface portion 62 is provided. Therefore, an electrical distance (electrical length) is shortened.

The resonance frequency of the antenna 6 has a property of being inversely proportional to the size and the length (the length of the inner diameter side, the length of one circumference) of the antenna 6 (the antenna element portion of the antenna 6), and when the electrical length is short, the frequency easily received by the antenna 6 and the frequency easily radiated tend to be higher than the desired frequency bands (that is, the frequency bands such as the L1 band (around 1.6 GHZ) and the L5 band (around 1.2 GHZ) in which the GNSS (GPS) signal is transmitted as described above) to be received by the antenna 6 of the present embodiment.

In the present embodiment, the element shape of the inner diameter side of the antenna 6 is not a perfect circle but an irregular shape, so that the length of the inner diameter side of the antenna 6 (the antenna element portion of the antenna 6) is increased and the electrical length is increased. Specifically, a distance of the inner periphery 60b from a substantially center of the annular shape (referred to as an “annular center cp”) in a plan view from the first direction I is non-uniform depending on a position thereof in the circumferential direction.

Specifically, as shown in FIG. 11A, the antenna 6 of the present embodiment includes at least one locking portion 63 provided on the inner periphery 60b and protruding side portions 65 protruding inward of the inner periphery 60b from the locking portion 63.

As shown in FIG. 8 and the like, the liquid crystal panel unit 7 constituting a display unit of the timepiece is accommodated in the device case 1 of the timepiece 100, and the shape of the inner diameter side of the antenna 6 is based on the shape along a glass shape of the liquid crystal panel unit 7 (note that the position of a side on the inner diameter side in the basic shape is referred to as a “reference position”).

As described above, a basic shape of the inner diameter side of the antenna 6 (the antenna element portion of the antenna 6) matches a shape of the glass of the liquid crystal panel unit 7 and has a shape in which a maximum area increases toward an inner side (the annular center cp side in FIG. 11A).

In the inner periphery 60b of the antenna 6, “first cutout portions 64” that are cut out in a direction away from the annular center cp than the “reference position” are provided, and the locking portion 63 is provided in the “first cutout portion 64” (for example, a side on a back side of the “first cutout portion 64”). The protruding side portion 65 is a portion that protrudes relatively inward (toward an annular center cp side in FIG. 11A) by providing the locking portion 63 in the “first cutout portion 64”.

The protruding side portion 65 may remain at the same position as the “reference position” along the glass shape of the liquid crystal panel unit 7 or may protrude inward in a direction closer to the annular center cp than the “reference position”.

A distance d1 (for example, the shortest distance from the annular center cp) from the annular center cp to the protruding side portion 65 shown in FIG. 11A is shorter than a distance d2 from the annular center cp to the back side of the first cutout portion 64.

In this way, by providing the first cutout portions 64 and the protruding side portions 65 in the inner periphery 60b to form an uneven shape in which the distance from the annular center cp is different, the length of the inner diameter side of the antenna 6 (the antenna element portion of the antenna 6) can be increased and the electrical length can be increased. Accordingly, it is possible to configure the antenna 6 that can easily receive radio waves in the desired frequency bands even when the diameter of the entire antenna 6 as a whole is reduced to achieve reduction in size.

The locking portion 63 provided on the inner periphery 60b of the antenna 6 locks the antenna 6 to the device case 1.

As shown in FIGS. 11A to 11C, the locking portions 63 of the present embodiment are disposed at three positions at intervals in the circumferential direction along the inner periphery 60b of the antenna 6 (the antenna element portion of the antenna 6).

As shown in FIG. 11B and the like, the locking portion 63 is a tongue piece bent downward in the first direction I from an end surface of the first cutout portion 64 formed in the top surface portion 61, and a locking hole 63a is formed therein. Even in the size of the locking portion 63 or the locking hole 63a, it can be expected to increase the length of the inner diameter side of the antenna 6 and increase the electrical length.

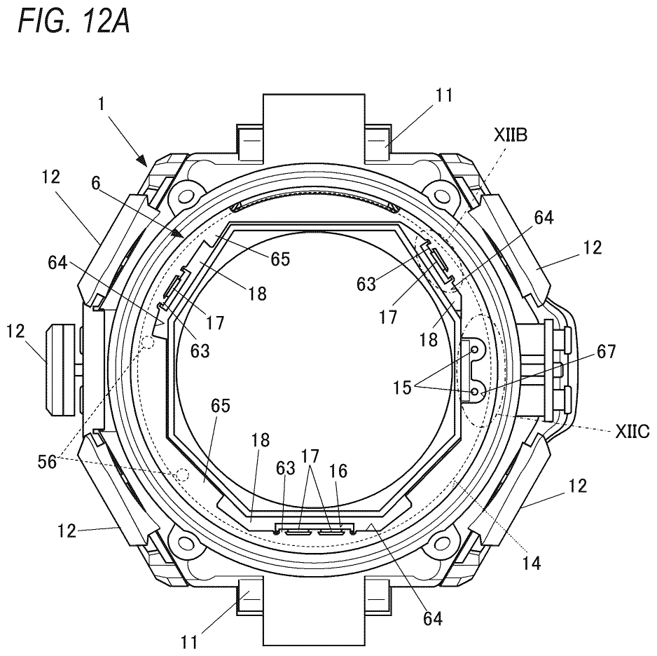

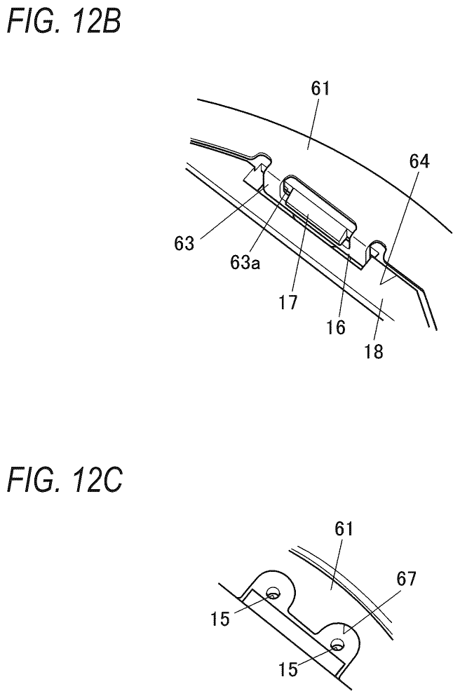

FIG. 12A is a plan view of a state in which the antenna of the present embodiment is incorporated in the device case as viewed from the first direction, FIG. 12B is an essential portion perspective view in which an XIIB portion surrounded by a one-dot chain line in FIG. 12A is enlarged, and FIG. 12C is an essential portion perspective view in which an XIIC portion surrounded by an one-dot chain line in FIG. 12A is enlarged.

As shown in FIGS. 12A and 12B, the device case 1 has locked portions at positions protruding inward of the device case 1 and corresponding to the locking portions 63 of the antenna 6. Thus, by providing the locked portion at the position protruding toward the inside of the device case 1, the thickness of the device case 1 can be increased at least at the portion, and the strength of the device case 1 is maintained.

In the present embodiment, the locked portion of the device case 1 includes a recessed portion 16 that receives the tongue-shaped locking portion 63, and a locking claw 17 that protrudes from the inside of the recessed portion 16 and is locked to the locking hole 63a of the locking portion 63 when the locking portion 63 is inserted into the recessed portion 16. The locking claw 17 has some spring properties, and has a structure in which, the locking claw 17 avoids the locking portion 63 that is slightly bent and inserted when the antenna 6 is disposed above (from an upper side in the first direction I of) the device case 1 and the locking portion 63 is inserted into the recessed portion 16, and the locking claw 17 is not easily pulled out when fitted into the locking hole 63a.

When the locked portion on the device case 1 side and the locking portion 63 of the antenna 6 are fitted to each other in this way, the antenna 6 is fixed to the device case 1. The configurations of the locking portion 63 of the antenna 6 and the locked portion on the device case 1 side are not limited to those illustrated here.

As described above, as shown in FIGS. 10, 12A, and 12C, the hole portion 15 penetrating vertically is formed in the device case 1 at a position where the board-panel contact member 46 for connecting the solar panel 4 to the circuit board 5 is disposed. In the present embodiment, two board-panel contact members 46 are provided, and two hole portions 15 on the device case 1 side are also provided accordingly.

In the portion where the hole portion 15 is formed, a portion of the inner periphery 60b of the antenna 6 is cut out to form the cutout portion 67 so as to avoid the position where the board-panel contact member 46 is disposed. The cutout portion 67 also has a function of forming unevenness on the inner periphery 60b of the antenna 6 and increasing the length of the antenna 6 (antenna element portion of the antenna 6) on the inner diameter side to increase the electrical length.

As described above, in the present embodiment, the antenna 6 is reduced in size to store the antenna 6 in the device case 1. However, when the antenna 6 and the board-panel contact member 46 are disposed to be easily brought close to each other due to the reduction in size, the respective members are easily electrically coupled to each other, and there is a problem that a loss occurs due to each resistance component (the antenna gain decreases).

In this regard, in the present embodiment, the cutout portion 67 is formed in the antenna 6 to avoid the position where the board-panel contact member 46 is disposed, and the board-panel contact member 46, which is a coil spring, is disposed at the position where the cutout portion 67 is provided to connect the solar panel 4 to the circuit board 5. Accordingly, it is possible to suppress the occurrence of loss (a decrease in antenna gain) due to each resistance component caused by electrical coupling of the members.

Note that electrical coupling is also likely to occur by looping from the solar panel 4 to the circuit board 5 (solar panel connection terminal of the circuit board 5) via one board-panel contact member 46 and from the circuit board 5 to the solar panel 4 via the other board-panel contact member 46, but the looping coupling can also be suppressed by forming the cutout portion 67 in the antenna 6 to avoid the position where the board-panel contact member 46 is disposed, disposing the board-panel contact member 46, which is a coil spring, in this portion, and connecting the solar panel 4 to the circuit board 5.

As shown in FIG. 12A and the like, in the device case 1, a groove portion 14 that receives (accommodates) at least the side surface portion 62 is formed at a position corresponding to the side surface portion 62 when the antenna 6 (the antenna element portion of the antenna 6) is disposed in the device case 1. Accordingly, at least a portion of the side surface portion 62 (that is, at least a portion of an inner side surface and an outer side surface of the side surface portion 62, and a bottom surface of the side surface portion 62) is in contact with the device case 1.

In the present embodiment, the groove portion 14 has a shape substantially along the side surface portion 62 of the antenna 6, and when the side surface portion 62 of the antenna 6 is fitted into the groove portion 14, the groove portion 14 of the device case 1 and the side surface portion 62 of the antenna 6 come into close contact (adherence) with each other.

When the antenna 6 (the antenna element portion of the antenna 6) is reduced in size, the electrical distance (electrical length) becomes shorter (smaller), which weakens the radiation effect of the antenna 6 and causes the problem that the antenna 6 does not function normally. In this regard, by fitting the side surface portion 62 of the antenna 6 into the groove portion 14 of the device case 1 and bringing the antenna 6 and the device case 1 made of the resin, which is a dielectric, into close contact (adherence) with each other, it is possible to suppress a decrease in the radiation effect of the antenna 6.

In general, the more the length and size of the antenna match the frequency and wavelength of the radio waves, the more efficient it will be (the better the antenna performance will be).

However, as described above, when the size and the length of the antenna 6 (the antenna element of the antenna 6) are reduced in order to fit the antenna 6 in the device case 1, the electrical distance (electrical length) is shortened, and the frequencies that are easily received and easily radiated by the antenna 6 are higher than the frequency band such as the L1 band (around 1.6 GHZ) and the L5 band (around 1.2 GHz) at which the desired frequency band (that is, GNSS (GPS) as described above) signal is transmitted.

In this regard, in the case where the antenna 6 (the antenna element portion of the antenna 6) is in the air and in the case where the antenna 6 (the antenna element portion of the antenna 6) is surrounded by the dielectric such as the resin material, it is confirmed that the wavelength of the radio wave becomes shorter in the case where the antenna 6 is surrounded by the dielectric in accordance with the relative dielectric constant.

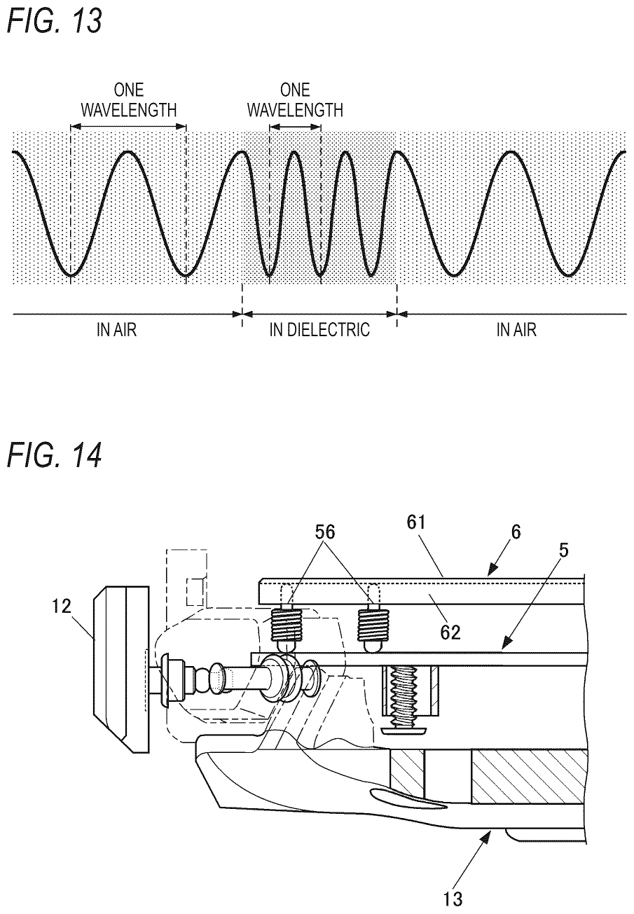

That is, as shown in an illustrative diagram of FIG. 13, the effect of “wavelength shortening of radio waves” is observed in which an original length of one period (length of one wavelength) of the wavelength itself is shortened in a dielectric.

The device case 1 of the embodiment is a case formed of a resin material. More specifically, a resin case containing a substance for increasing the relative dielectric constant is preferably used as a portion of the material.

Therefore, if the antenna 6 (the antenna element portion of the antenna 6) is brought into close contact with the device case 1 as much as possible, the effect of “wavelength shortening of radio waves” can be effectively obtained, and even when the antenna 6 (the antenna element portion of the antenna 6) is reduced in size, the antenna 6 can resonate in a low-frequency band (the desired frequency band such as the L1 band and the L5 band described above).

The shape (width, depth, and the like) of the groove portion 14 of the device case 1 preferably matches the shape of the side surface portion 62 of the antenna 6 as much as possible, and the antenna 6 (antenna element (antenna element) portion of the antenna 6) and the device case 1 are configured to be in a close contact (adhering) state by fitting the side surface portion 62 into the groove portion 14. That is, in a state in which the side surface portion 62 is fitted into the groove portion 14, it is desirable that the inner side surface and the outer side surface of the side surface portion 62, a lower end surface, and the like come into close contact with an inner side surface of the groove portion 14.

Further, when the antenna 6 is disposed in the device case 1, at least a portion of a lower surface of the top surface portion 61 is in contact with the device case 1. Also in this case, by adjusting the depth of the groove portion 14 to the height of the side surface portion 62, when the side surface portion 62 is fitted into the groove portion 14, the top surface portion 61 is also disposed in contact with the upper surface of the device case 1 without floating, and thus the effect of “wavelength shortening of radio waves” can be similarly obtained.

Further, for the same reason, it is preferable that a locking part of the locking portion 63 and the locked portion of the device case 1 are brought into close contact (adherence) with each other with as little gap as possible.

Further, by adopting a configuration in which the antenna 6 (the antenna element portion of the antenna 6) and the device case 1 are brought into close contact (adherence) with each other, it is possible to similarly expect the effect of suppressing the decrease in the radiation effect of the antenna 6 due to a synergistic effect between the antenna 6 and the device case 1, which is the dielectric.

From the viewpoint that filling the periphery of the antenna 6 with the dielectric (resin material) enables the antenna 6 to resonate in the low-frequency band even when the antenna 6 (the antenna element portion of the antenna 6) is reduced in size, it is preferable to dispose the dielectric such as the resin material on, for example, a lower surface side (back surface side, surface facing the inside of the device case 1, surface side to which the solar panel 4 is attached in the present embodiment) of the windshield member 3, so as to fill the gap between the antenna 6 (the antenna element portion of the antenna 6) and the windshield member 3.

By filling the periphery of the antenna 6 with the dielectric (resin material) to fill the gap, a further wavelength shortening effect can be expected, and it can be expected to improve the antenna performance in the low-frequency band (a desired frequency band such as the L1 band and the L5 band) when the small-sized antenna 6 is adopted.

The antenna 6 (the antenna element portion of the antenna 6) is connected to the circuit board 5 via board-antenna contact members 56 (antenna contact members).

FIG. 14 is a main portion side view showing a connection portion between the antenna and the circuit board.

The board-antenna contact member 56 is, for example, a coil spring or a pogo pin having a spring therein. One end side of the board-antenna contact member 56 is in pressure contact with the top surface portion 61 of the antenna 6 (the antenna element portion of the antenna 6), and the other end side is in contact with a GPS circuit (not shown) of the circuit board 5.

When the board-antenna contact member 56 for connecting to the circuit board 5 is received by the top surface portion 61 of the antenna 6, the connection between the antenna 6 and the circuit board 5 can be a contact in the thickness direction (vertical direction) of the timepiece 100, and a contact pressure in the contact portion between the antenna 6 and the circuit board 5 can be sufficiently secured.

The number of the board-antenna contact members 56 connecting the antenna 6 to the circuit board 5 may be one or more, and may be three or more. In the illustrated example of FIG. 14 and the like, a case where the board-antenna contact members 56 are provided at two positions is illustrated.

At the positions where the board-antenna contact members 56 including the springs are pressed, the top surface portion 61 of the antenna 6 may be pushed up by the board-antenna contact member 56. Therefore, as shown in FIG. 12A and the like, the position at which the board-antenna contact member 56 is disposed is preferably in the vicinity of the locking position where the locking portion 63 for locking the antenna 6 and the device case 1 is provided.

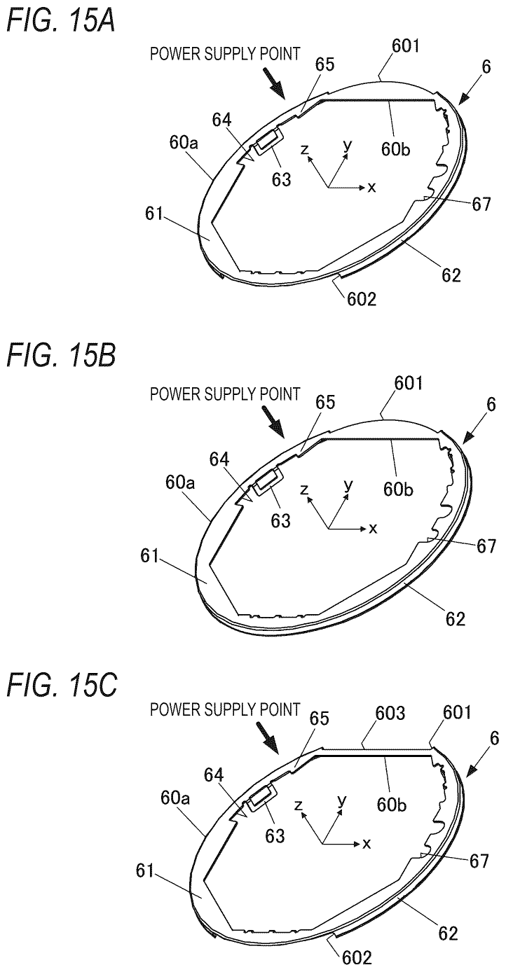

It is also confirmed that when the shape of the antenna 6 (the antenna element portion of the antenna 6) changes, the gain (the characteristic of the gain) of the antenna 6 changes. From FIGS. 15A to 15C, in a case where a 3 o'clock-9 o'clock direction of the antenna 6 (the antenna element portion of the antenna 6) is taken as an x axis and a 6 o'clock 12 o'clock direction is taken as a y axis, in a case where a power supply point is assumed to be located between the 9 o'clock position and the 12 o'clock position (that is, around the position of 45 degrees between the x axis and the y axis as shown in FIG. 11A and the like), for example, when the y axis side of the antenna 6 (the antenna element portion of the antenna 6) is cut out, the gain of the antenna 6 (the characteristic of the gain) changes depending on the degree of cutting.

For example, in FIG. 15A, a cutout portion 601 is formed by cutting out a portion of the side surface portion 62 on the 12 o'clock side of the y axis of the antenna 6, and a cutout portion 602 is formed by cutting a portion of the side surface portion 62 on the 6 o'clock side. The cutout portions 601 and 602 formed in the side surface portion 62 are referred to as “third cutout portions”.

On the other hand, in FIG. 15B, the cutout portion 601 is formed by cutting out the portion of only the side surface portion 62 on the 12 o'clock side of the y axis of the antenna 6, and the cutout portion is not formed in the side surface portion 62 on the 6 o'clock side. The antenna (antenna element) having the shape shown in FIG. 15B is referred to as “Comparative Example 1”.

Further, for example, in FIG. 15C, the cutout portion 602 (third cutout portion) is formed by cutting out the portion of the side surface portion 62 on the 6 o'clock side of the y axis of the antenna 6, and a cutout portion 603 is formed by cutting out a portion of the top surface portion 61 on the 12 o'clock side. The cutout portion 603 formed in the top surface portion 61 is referred to as a “second cutout portion”. The antenna (antenna element) having the shape shown in FIG. 15C is referred to as “Comparative Example 2”.

In this embodiment, the antenna 6 having the shape illustrated in FIG. 15A is adopted, in which cutout portions 601 and 602 are formed as the “third cutout portions” in the side surface portion 62 on the 12 o'clock side and the side surface portion 62 on the 6 o'clock side of the y axis of antenna 6.

When the cutout portion 601 is formed by partially cutting out only the side surface portion 62 at the 6 o'clock position in the y-axis direction of the antenna 6 (the antenna element portion of the antenna 6) (in the case of the antenna shape shown in FIG. 15B), the antenna gain is reduced in both the L5 band and the L1 band (average value) as compared with when the side surface portions 62 at the 6 o'clock position and the 12 o'clock position in the y-axis direction of the antenna 6 (the antenna element portion of the antenna 6) are partially cut out to form the cutout portion 601 and 602 (in the case of the antenna shape of the embodiment shown in FIG. 15A).

Further, when the cutout portion 601 is formed by partially cutting out the side surface portion 62 at the 6 o'clock position in the y-axis direction of the antenna 6 (the antenna element portion of the antenna 6) and the cutout portion 603 is formed by partially cutting out the top surface portion 61 at the 12 o'clock position in the y-axis direction (in the case of the antenna shape shown in FIG. 15C), the antenna gain is lower in the L1 band (average value) than in the case of FIG. 15B, although almost no difference is observed in the L5 band compared to the case of the antenna shape of the embodiment shown in FIG. 15A.

As described above, the shape of the antenna 6 (the portion of the antenna element of the antenna 6), which is not the perfect circle, can be adjusted by slightly shortening the end portion on the x-axis side, enlarging the end portion on the y-axis side, and changing the amount of metal (metal volume) at positions +45 degrees from the feed point (feed position), so that just the right gain can be obtained for radio waves in the desired frequency bands.

It should be noted that how much which parts should be changed in order to achieve better gain for radio waves in the desired frequency bands can be adjusted according to various surrounding conditions, such as what kind of metal components are disposed in the periphery of the antenna 6 (the antenna element portion of the antenna 6).

The adjustment of the metal amount (metal volume) of the antenna 6 may be performed by providing the cutout portion in at least a portion of the antenna 6 (the antenna element portion of the antenna 6) or by providing a hole portion.

Since the gain of the antenna 6 depends on various conditions, such as metal components disposed in the periphery of the antenna 6 as described above, the board-panel contact member 46 (coil spring (spring)) that connects the solar panel 4 to the circuit board 5 is disposed in the portion corresponding to the cutout portion 67 formed in the inner periphery 60b of the antenna 6 as described above.

The configuration such as the shape of the board-panel contact member 46 is not particularly limited, but the gain of the antenna 6 is affected by the configuration of the board-panel contact member 46. Specifically, the gain of the antenna 6 is set based on any one of a wire diameter, the number of effective turns, and the length of the expansion and contraction of the coil spring (board-panel contact member 46).

That is, it has been confirmed that when the inductance (calculated inductance) of the coil spring (spring) serving as the board-panel contact member 46 is increased, the gain of the antenna 6 is improved.

Therefore, in the present embodiment, in designing the specifications (shape and the like) of the coil spring (spring), the inductance of the coil spring (spring) serving as the board-panel contact member 46 is made as large as possible.

Generally, when the effective number of turns [N] of the coil spring and the length [mm] of the expansion and contraction portion are the same, the smaller the wire diameter [mm] of the spring, the smaller the calculated value (calculated L value) of the inductance. It was found that when the calculated value (calculated L value) of the inductance decreased by using this characteristic, the antenna gain of the clockwise polarized wave of the L5 band obtained as the GPS antenna decreased, and the antenna gain of the clockwise polarized wave of the L1 band (average value) obtained as the GPS antenna decreased.

Therefore, it has been confirmed that the gain of the antenna 6 is improved (enhanced) in both the L5 band and the L1 band when the calculated value (calculated L value) of the inductance of the coil spring (spring) serving as the board-panel contact member 46 is large. This is considered to be because the larger the inductance of the coil spring (spring) serving as the board-panel contact member 46, the more the flow of the high-frequency current is blocked, and the reduction of the gain of the antenna 6 is improved.

The generated current by the solar panel 4 is a low frequency (alternating current having a frequency equal to or lower than a predetermined frequency) or a direct current. Therefore, even when the inductance of the coil spring (spring) serving as the board-panel contact member 46 is large, the generated current by the solar panel 4 is supplied to the circuit board 5 without being blocked, and a charging function by the solar panel 4 is not inhibited.

It should be noted that in designing the coil spring (spring) as the actual board-panel contact member 46, it is preferable to design it in a way that satisfies various conditions, taking into consideration the balance between the stress, tension, and the like of the spring when actually connecting the solar panel 4 to the circuit board 5.

As shown in FIG. 8 and the like, shield members 51 serving as protective members are provided on the circuit board 5 in the present embodiment. The shield member 51 is placed as a protective member that covers at least a portion of circuit elements (electronic components, not shown) on the circuit board 5. The shield member 51 is formed in a box shape using, for example, sheet metal, and a side surface thereof is fixed onto the circuit board 5.

The configuration for fixing the shield member 51 onto the circuit board 5 is not particularly limited, and for example, the shield member 51 may be directly soldered or may be fixed onto the circuit board 5 via another metal component and the like. In either case, the shield member 51 comes into contact with the circuit board 5 serving as the ground (GND) (directly or indirectly) at the side surface thereof and has the same potential as the ground.

In the present embodiment, as described above, the antenna 6 (the antenna element portion of the antenna 6) has the top surface portion 61 and the side surface portion 62, but increasing the surface area of the antenna 6 (the antenna element portion of the antenna 6) is advantageous from a standpoint of radio wave radiation. Therefore, in particular, in the plan view from the first direction I, the annular top surface portion 61 is formed as wide as possible toward the annular center cp. Therefore, in particular, the top surface portion 61 faces the circuit board 5 in a substantially parallel manner, and when they come close to each other, the capacitive coupling is likely to occur as in the “parallel plate capacitor”.

In this respect, a surface (upper surface) of a portion of the shield member 51 that covers the circuit elements by surrounding is disposed at a position higher than the surface (upper surface) of the circuit board 5, and is closer to the antenna 6 (the antenna element portion of the antenna 6) than the surface (upper surface) of the circuit board 5 itself is.

When the shield member 51 having the same potential as the ground is close to the antenna 6 (particularly, the top surface portion 61) in a substantially parallel positional relation, capacitive coupling is likely to occur as in the “parallel plate capacitor”, and when the capacitive coupling is increased, the performance (antenna efficiency) of the antenna 6 greatly deteriorates, which is not preferable.

Therefore, in the present embodiment, the antenna 6 and the shield members 51 are disposed at positions not overlapping each other in the plan view from the first direction I orthogonal to the surface of the circuit board 5. Accordingly, the antenna 6 and the shield members 51 can be prevented from being in the substantially parallel positional relation.

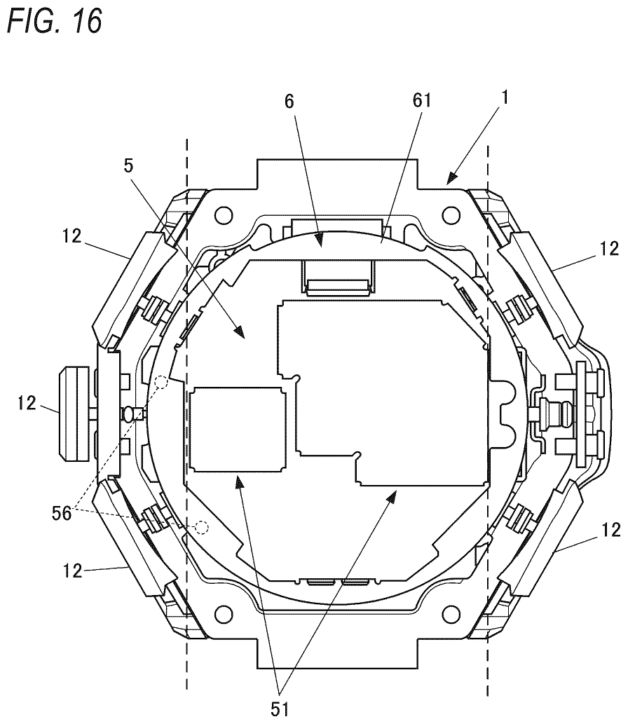

FIG. 16 is a plan view showing a configuration example (an arrangement example of the shield members and the like) inside the timepiece in a plan view from the first direction. FIG. 16 shows an arrangement state on the circuit board 5 by removing the bezel 2, the windshield member 3, and the like.

As indicated by broken lines in FIG. 16, the shield member 51 provided on the circuit board 5 is disposed not to overlap the antenna 6 in the plan view from the first direction I. More specifically, as described above, the antenna 6 has at least the outer periphery 60a and the inner periphery 60b when viewed from the first direction I, but the shield member 51 is disposed inside the inner periphery 60b in the plan view from the first direction I.

It has been confirmed that by disposing the shield member 51 in this manner, even when the shield member 51 is mounted on the circuit board 5, the antenna efficiency does not substantially deteriorate as compared with a state in which the shield member 51 is not mounted.

By disposing the shield member 51 at a position as shown in FIG. 16, the shield member 51 does not overlap the device case 1 in the plan view from the first direction I.

Accordingly, the capacitive coupling between the antenna 6 and the shield member 51 can be more reliably prevented.

The upper surface of the shield member 51, which is the protective member, may have a shape in which at least a portion thereof is inclined to the circuit board 5.

For example, in the plan view from the first direction I, the height of the upper surface of the shield member 51 decreases as the distance from a center (the annular center cp) of the antenna 6 (the antenna element portion of the antenna 6) increases, so that the capacitive coupling between the antenna 6 and the shield members 51 is less likely to occur.

Therefore, in order to provide the shield member 51 on the circuit board 5, it is preferable to perform adjustment in a design stage such that the shape of the shield member 51 does not overlap the antenna 6, or the antenna 6 is cut out (for example, a portion overlapping the shield member 51 in the plan view from the first direction I is cut out) in a shape that avoids the arrangement position of the shield member 51 in a portion where the shield member 51 needs to be disposed due to reasons such as there being circuit elements that absolutely need to be protected.

### Operation

As described above, in the timepiece 100 that is the electronic device according to the present embodiment, the shield members 51 are mounted on the circuit board 5. The shield members 51 are in contact with the circuit board 5 which is the ground and have the same potential as the ground. Therefore, when the shield members 51 are close to the antenna 6 (the antenna element portion of the antenna 6) in a nearly parallel state, the capacitive coupling is likely to occur as in the “parallel plate capacitor”.

In this regard, in the present embodiment, by devising the arrangement and shape of the shield member 51 and the antenna 6, the shield member 51 and the antenna 6 are disposed not to overlap each other in the plan view from the first direction I orthogonal to the surface of the circuit board 5, and the capacitive coupling is less likely to occur.

Further, the shield member 51 does not overlap the device case 1 in the plan view from the first direction I, and the capacitive coupling between the antenna 6 and the shield member 51 is more reliably prevented.

### Effects

As described above, the timepiece 100, which is an electronic device according to the present embodiment, includes the antenna 6 and the circuit board 5 on which the shield members 51 that cover at least a portion of the circuit elements is mounted, and the antenna 6 (the antenna element portion of the antenna 6) and the shield members 51 are disposed at positions that do not overlap each other in the plan view from the first direction I orthogonal to the surface of the circuit board 5.

The shield members 51 have the same potential as the circuit board 5 which is the ground, and are provided closer to the antenna 6 than the surface of the circuit board 5 is. Therefore, when the shield members 51 and the antenna 6 (the antenna element portion of the antenna 6) overlap each other, the capacitive coupling is likely to occur as in the “parallel plate capacitor”. When the capacitive coupling between the shield members 51 having the same potential as the ground and the antenna 6 is increased, the performance (antenna efficiency) of the antenna 6 significantly deteriorates.

In this regard, if the overlap between the shield members 51 and the antenna 6 is avoided as in the present embodiment, capacitive coupling is less likely to occur, and deterioration of the antenna performance can be prevented.

Further, the antenna 6 (the antenna element portion of the antenna 6) is formed in the annular shape having at least the outer periphery 60a and the inner periphery 60b in the plan view from the first direction I.

Even in the case where the circuit board 5 on which the shield members 51 are mounted is disposed below the antenna 6 (in particular, the top surface portion 61), by preventing the antenna 6 and the shield member 51 having the same potential as the ground from being close to each other in the substantially parallel positional relation, the capacitive coupling as in the “parallel plate capacitor” can be avoided and the deterioration of the antenna performance can be prevented.

Further, the shield member 51 does not overlap the device case 1 in the plan view from the first direction I.

Accordingly, the capacitive coupling between the antenna 6 and the shield member 51 can be more reliably prevented, and the deterioration of the antenna performance can be prevented.

The upper surface of the shield member 51, which is the protective member, may have a shape in which at least a portion thereof is inclined to the circuit board 5. For example, in the plan view from the first direction I, the height of the upper surface of the shield member 51 may decrease as the distance from the center (the annular center cp) of the antenna 6 (the antenna element portion of the antenna 6) increases.

In this way, the capacitive coupling between the antenna 6 and the shield member 51 is less likely to occur, and the deterioration of the antenna performance can be prevented.

When the electronic device in which the antenna 6 is incorporated is the timepiece 100, the entire device can be reduced in size as compared with the case where the exterior member is used as the antenna 6, and the antenna 6 can be protected from external impact, corrosion, and the like.

Further, even in the case where the shield member 51 that is in contact with the circuit board 5, which is the ground, and has the same potential as the ground is mounted on the circuit board 5, the shield member 51 and the antenna 6 (the antenna element portion of the antenna 6) do not overlap each other in the plan view from the first direction I, and thus the capacitive coupling can be avoided and the deterioration of the antenna performance can be prevented.

Accordingly, the GNSS (GPS) signal can be received by the antenna 6, and accurate time correction and the like can be performed.

Although the embodiment of the present invention has been described above, the present invention is not limited to the embodiment, and various modifications can be made without departing from the gist thereof.

For example, in the present embodiment, a case where the electronic device is the timepiece 100 is illustrated, but the electronic device is not limited thereto.

The present invention can be widely applied to any device used by incorporating the antenna 6, and in addition to various types of smart watches and sports watches, the present invention can be applied to electronic devices that record various types of data along with time, such as a heart rate meter and a blood pressure meter.

Although some embodiments of the present invention has been described above, the scope of the present invention is not limited to the above-described embodiments, and include the scope of the invention defined by the claims and the equivalents thereof.

The present application is based on a Japanese Patent Application (Japanese Patent Application No. 2022-152059) filed on Sep. 26, 2022, and contents thereof are incorporated herein by reference.

According to the present disclosure, it is possible to provide an electronic device and an electronic timepiece capable of suppressing a reduction in antenna efficiency.

### REFERENCE SIGNS LIST

1: Device case
2: Bezel
21: First bezel
22: Second bezel
211: Protrusion forming portion
212: Main body portion
3: Windshield member
4: Solar panel
40a: Outer periphery
40b: Inner periphery
45: Contact portion
46: Board-panel contact member (panel contact member)
5: Circuit board
51: Shield member
56: Board-antenna contact member (antenna contact member)
6: Antenna
60a: Outer periphery
60b: Inner periphery
61: Top surface portion
62: Side surface portion
63: Locking portion
64: First cutout portion
67: Cutout portion
601: Cutout portion (third cutout portion)
602: Cutout portion (third cutout portion)
603: Cutout portion (second cutout portion)
7: Liquid crystal panel unit
100: Timepiece (electronic timepiece, electronic device)
cp: Annular center
I: First direction (viewing direction)
II: Second direction (side)
a: First region
B: Second region

1. An electronic device comprising:
an antenna; and
a circuit board on which a protective member is placed, the protective member covering at least a portion of circuit elements on the board,
wherein the antenna and the protective member are disposed at positions not overlapping each other in a plan view from a first direction orthogonal to a surface of the circuit board.

2. The electronic device according to claim 1, wherein the antenna is formed in a substantially annular shape having at least an outer periphery and an inner periphery in the plan view from the first direction.

3. The electronic device according to claim 2, wherein the protective member is disposed inside the inner periphery in the plan view from the first direction.

4. The electronic device according to claim 1, further comprising:
a device case configured to accommodate the antenna,
wherein the protective member is disposed at a position not overlapping the device case in the plan view from the first direction.

5. The electronic device according to claim 1, wherein a potential of the protective member is a ground potential.

6. The electronic device according to claim 1, wherein at least a portion of an upper surface of the protective member is partially inclined to the circuit board.

7. An electronic timepiece comprising:
an antenna; and
a circuit board on which a protective member is placed, the protective member covering at least a portion of circuit elements on the board,
wherein the antenna and the protective member are disposed at positions not overlapping each other in a plan view from a first direction orthogonal to a surface of the circuit board.

8. The electronic timepiece according to claim 7, wherein the antenna is formed in a substantially annular shape having at least an outer periphery and an inner periphery in the plan view from the first direction.

9. The electronic timepiece according to claim 8, wherein the protective member is disposed inside the inner periphery in the plan view from the first direction.

10. The electronic timepiece according to claim 7, further comprising:
a device case configured to accommodate the antenna,
wherein the protective member is disposed at a position not overlapping the device case in the plan view from the first direction.

11. The electronic timepiece according to claim 7, wherein a potential of the protective member is a ground potential.

12. The electronic timepiece according to claim 7, wherein at least a portion of an upper surface of the protective member is partially inclined to the circuit board.
